(19) United States
(12) Patent Application Publication
(10) Pub. No.: US 2017/0090417 A1
(43) Pub. Date: Mar. 30, 2017

(54) IMAGE FORMING APPARATUS

(71) Applicant: CANON KABUSHIKI KAISHA, Tokyo (JP)

(72) Inventors: Mahito Yoshioka, Numazu-shi (JP); Satoru Taniguchi, Mishima-shi (JP); Hirohiko Aiba, Suntou-gun (JP); Taisuke Minagawa, Suntou-gun (JP)

(21) Appl. No.: 15/275,124

(22) Filed: Sep. 23, 2016

(30) Foreign Application Priority Data
Sep. 30, 2015 (JP) 2015-193860

(51) Int. Cl. G03G 21/20; G03G 15/20

(52) U.S. Cl. CPC G03G 21/206; G03G 15/2014

(57) ABSTRACT

An image forming apparatus includes an image forming section that forms a toner image on a recording material, a fixing section that fixes the toner image onto the recording material, an air passage disposed between the fixing section and the image forming section to be adjacent to a conveying region in which the recording material is conveyed from the image forming section toward the fixing section, an air-blowing unit that generates, in the air passage, airflow in a longitudinal direction of the fixing section, a first partition facing a conveying path region and partitioning the air passage with respect to the conveying region, and a second partition partitioning the air passage. A total area of an opening formed by the first partition in the air passage is smaller than a total area of an opening formed by the second partition in the air passage.

### BACKGROUND

Field

Aspects of the present invention generally relate to an image forming apparatus, such as a copying machine, a printer, or a facsimile machine, that includes an image forming unit and a fixing unit, which heats and fixes a toner image that has been transferred from the image forming unit to a recording material onto the recording material, and more particularly to an air duct for cooling the image forming unit.

Description of the Related Art

According to the related art, there has been a tendency for the length of a conveying path region, along which recording materials are to be transported, in an image forming apparatus, such a copying machine, a printer, or a facsimile machine, to be reduced in order to improve the printing speed and to reduce the first print-out time. Accordingly, an arrangement is selected in which an image forming unit that forms a toner image and a fixing unit that heats and fixes the toner image onto a recording material are arranged so as to be close to each other. The image forming unit includes a portion (toner developing unit) to which a toner is to be supplied and a portion (cleaning unit) that cleans waste toner generated by performing image formation. However, radiant heat from the fixing unit, which is arranged so as to be close to the image forming unit, and an increase in the temperature of the image forming unit, which is caused by the image forming unit itself, cause the toner in the above-mentioned portions to soften?, and this may lead to problems such as failure to form a toner image and clogging of waste toner.

In order to suppress the occurrence of such problems, in Japanese Patent No. 5223275 (hereinafter referred to as Patent Document 1), there has been proposed an air-passage configuration in which an air duct that enables cooling air, which cools an image forming unit, to flow in the longitudinal direction of the image forming unit is provided in a space between the image forming unit and a fixing unit. An intake duct is connected to a side surface of the air duct, the side surface being located on the side opposite to the side on which a conveying path region is disposed. A cooling fan is disposed at a location spaced apart from the image forming unit, and the cooling air is guided from the intake duct to the air duct in such a manner as to cool the image forming unit. However, the intake duct is connected to the air duct not at an angle in the longitudinal direction of the image forming unit but at an angle close to right angles due to the available space limitation. Thus, the air passage is bent at substantially right angles at a position at which the intake duct and the air duct are connected to each other, and the cooling air is less likely to be guided within the air duct in the longitudinal direction of the image forming unit from a portion in which the intake duct and the air duct are connected to each other, so that some of the cooling air overflows to the side on which the conveying path region is disposed. As a result, the cooling air flows to the side on which the fixing unit is disposed and cools a fixing component, and this causes a fixing failure of a toner image.

Although it is desirable that the air duct be hermetically sealed in order to suppress the occurrence of such problems, the image forming unit and the fixing unit are often configured to be mounted and unmounted into and from an image forming apparatus. Consequently, it is difficult to realize the hermetically-sealed configuration from the standpoints of ensuring a space required when mounting and unmounting these units into and from the image forming apparatus and avoiding interference between these units and internal components of the image forming apparatus.

Accordingly, in Patent Document 1, a side surface of the air duct, the side surface facing the position at which the intake duct is connected to the air duct, has a labyrinth configuration formed by a pair of guide ribs, each of which is arranged so as to project from one of the fixing unit and the image forming unit and which overlap each other in the top-bottom direction. With the labyrinth configuration, the cooling air, which flows into the air duct from the intake duct, is guided within a substantially hermetically-sealed space, and the cooling air is prevented from overflowing to the side on which the conveying path region is disposed.

In Patent Document 1, the image forming unit is configured to be mounted and unmounted into and from the image forming apparatus in the longitudinal direction of the image forming unit. Accordingly, the lower guide rib on the image forming unit side and the upper guide rib on the fixing unit side are arranged at a gentle angle with respect to a mounting direction of the image forming unit. With this configuration, when mounting the image forming unit onto the image forming apparatus, the guide ribs gradually come close to each other without interfering with each other. After the image forming unit has been mounted in the image forming apparatus, the guide ribs are arranged so as to be close to each other, and the labyrinth configuration can be achieved by the combination of the upper and lower guide ribs.

However, the above-described configuration has the following problem.

That is to say, since the directions in which the image forming unit is mounted into and unmounted from the image forming apparatus and the longitudinal direction of the guide ribs are approximately parallel to each other, even if an allowance is made for a space required in the mounting and unmounting directions of the image forming unit, the distance between the upper and lower guide ribs in an interference direction (direction perpendicular to the longitudinal direction of the guide ribs) does not greatly change.

However, unlike the above-described configuration, in the case of mounting and unmounting the image forming unit into and from the image forming apparatus in the directions perpendicular to the longitudinal direction of the image forming unit, the interference direction of the upper and lower guide ribs and the mounting and unmounting directions of the image forming unit substantially match each other. Thus, the influence of the above-mentioned required space in the above-mentioned interference direction increases. In the case where the distance between the upper and lower guide ribs is set by making an allowance for the required space in such a manner that the upper and lower guide ribs will not interfere with each other, the distance between the guide ribs increases, which in turn results in a positional relationship in which the labyrinth effect cannot be expected.

### SUMMARY

An image forming apparatus according to an aspect of the present invention that forms an image on a recording material includes an image forming section that forms an unfixed toner image on a recording material, a fixing section that heats the recording material, on which the unfixed toner image has been formed in the image forming section, and fixes the unfixed toner image onto the recording material, an air passage that is disposed between the fixing section and the image forming section and that is adjacent to a conveying region in which the recording material is conveyed from the image forming section toward the fixing section, an air-blowing unit configured to generate, in the air passage, airflow directed in a longitudinal direction of the fixing section, a first partition that faces a conveying path region and partitions the air passage with respect to the conveying region, and a second partition that partitions a region in the air passage, the second partition being disposed in such a manner as to oppose the conveying region across the first partition. A total area of an opening formed by the first partition in the air passage is smaller than a total area of an opening formed by the second partition in the air passage.

Further features of aspects of the present invention will become apparent from the following description of exemplary embodiments with reference to the attached drawings.

### BRIEF DESCRIPTION OF THE DRAWINGS

FIG. 1 is a schematic diagram of an image forming apparatus according to a first embodiment of the present invention.

FIG. 2 is a perspective view illustrating the positional relationship between an image forming unit and ducts and the like according to the first embodiment.

FIG. 3 is a cross-sectional side view illustrating the positional relationship between the image forming unit, a fixing unit, and the ducts and the like according to the first embodiment.

FIG. 4 is a top view illustrating the positional relationship between the image forming unit and the ducts and the like according to the first embodiment.

FIGS. 5A and 5B are cross-sectional side views illustrating advantageous effects of an auxiliary guide rib according to the first embodiment.

FIGS. 6A and 6B are top views illustrating the advantageous effects of the auxiliary guide rib according to the first embodiment.

FIGS. 7A to 7C are top views illustrating examples of the shape of the auxiliary guide rib according to the first embodiment.

FIG. 8 is a perspective view illustrating the positional relationship between an image forming unit and ducts and the like according to a second embodiment.

FIG. 9 is a cross-sectional side view illustrating the positional relationship between the image forming unit, a fixing unit, and the ducts and the like according to the second embodiment.

### DESCRIPTION OF THE EMBODIMENTS

An image forming apparatus according to aspects of the present invention will be described in detail with reference to the drawings. Note that dimensions, materials, shapes, and the relative positions of the components described in the following embodiments should be suitably changed in accordance with the configuration of an apparatus to which aspects of the present invention may be applied and in accordance with various conditions, and the scope of the present invention is not intended to be limited to the following embodiments.

### First Embodiment

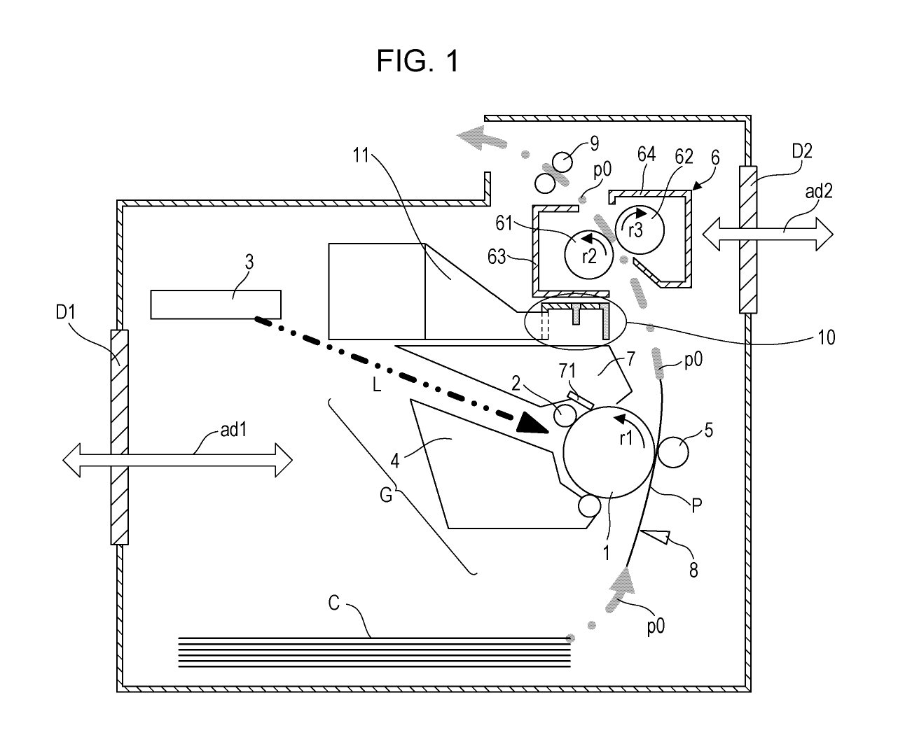

FIG. 1 is a schematic diagram of an image forming apparatus according to a first embodiment. The image forming apparatus according to the first embodiment is a laser printer that uses a transfer electro-photographic process.

The schematic configuration of the image forming apparatus will be described first.

The image forming apparatus includes an image forming unit (image forming section) G that includes a photoconductor drum 1, which serves as an image carrying member that carries an unfixed toner image, and a fixing unit (fixing section) 6 that is disposed adjacent to the image forming unit G. The fixing unit 6 fixes an unfixed toner image, which has been transferred to a recording material P, onto the recording material P by applying heat to the unfixed toner image and includes a conveying path region P0 along which the recording material P is to be conveyed from a transfer portion of the image forming unit G to the fixing unit 6. In this example, the fixing unit 6 is disposed above the image forming unit G in the vertical direction, and the conveying path region P0 extends in a top-bottom direction from a sheet-feeding portion of a recording-material cassette C, which is disposed below the image forming unit G in the vertical direction, toward the fixing unit 6 via the image forming unit G. The image forming unit G is disposed on one side of the conveying path region P0, and a transfer roller 5 that forms a transfer nip by being in contact with the photoconductor drum 1 of the image forming unit G is disposed on the conveying path region P0.

An air duct 10, which serves as an air passage that enables cooling air, which cools the image forming unit G, to flow in the longitudinal direction of the image forming unit G is disposed between the image forming unit G and the fixing unit 6. The air duct 10 is adjacent to the conveying path region P0. An intake duct 11 is connected to a side surface of the air duct 10, the side surface being located on the side opposite to the side on which the conveying path region P0 is disposed. The intake duct 11 is connected to a first end portion of the air duct 10 in the longitudinal direction of the air duct 10, and an exhaust duct 13 is connected to a second end portion of the air duct 10.

The configuration of each unit will be described in detail below.

The photoconductor drum (photoconductor) 1, a charging roller 2 that serves as a charging unit, a developing device 4 that serves as a developing unit (developing section), and a cleaning device 7 that serves as a cleaning unit, are integrated with one another so as to form the image forming unit G. The charging roller 2, the developing device 4, and the cleaning device 7 are disposed around the photoconductor drum 1.

The image forming unit G is capable of being mounted into and unmounted from the image forming apparatus. In the first embodiment, the image forming unit G is introduced and mounted into the image forming apparatus in mounting and unmounting directions indicated by arrow ad1 through a left door D1 of the image forming apparatus, the left door D1 being disposed on the side opposite to the side on which the conveying path region P0 is disposed with respect to the image forming unit G. The mounting and unmounting directions ad1 are the horizontal direction that is substantially perpendicular to a transport surface of the conveying path region P0 extending in the top-bottom direction.

The photoconductor drum 1 is driven so as to rotate in a counterclockwise direction indicated by arrow r1 at a predetermined peripheral speed. The charging roller 2 is in contact with the photoconductor drum 1, and a surface of the photoconductor drum 1 is uniformly charged by the charging roller 2 so as to have a predetermined polarity and a predetermined potential.

A scanner 3 outputs scanning light L, which is on-off-controlled in accordance with image information, and scans and irradiates the charged surface of the photoconductor drum 1. As a result of performing this scanning and irradiating operation, an electric charge in a light-exposed portion of the surface of the photoconductor drum 1 is removed, and an electrostatic latent image corresponding to the image information is formed on the surface of the photoconductor drum 1.

The electrostatic latent image is developed and visualized as a toner image by the developing device 4. Jumping development, two-component development, or the like is used as a method of developing such an electrostatic latent image, and image exposure and reversal development are often used in combination with each other.

The recording material P is fed from the recording-material cassette C, which serves as a recording-material accommodating unit, at a predetermined timing, sent to the conveying path region P0 in the image forming apparatus, and transported upward as indicated by an arrow. The toner image, which has been visualized, is transferred from the photosensitive drum 1 onto the recording material P, which has been introduced to the image forming apparatus, by the transfer roller 5, which serves as a transfer device.

Here, a leading end of the recording material P is detected by a sensor 8, and the timing of transportation of the recording material P is adjusted in such a manner that a position on the photosensitive drum 1 where the toner image is formed and a writing position at the leading end of the recording material P coincide with each other. The recording material P, which has been transported at a predetermined timing, is transported by being nipped between the photosensitive drum 1 and the transfer roller 5.

The recording material P, to which the toner image has been transferred, is transported to the fixing unit 6, and the toner image is heated and fixed onto the recording material P as a permanent image.

In contrast, residual toner that remains on the photosensitive drum 1 after the toner image has been transferred to the recording material P is collected by a cleaning blade 71, which is in contact with the photosensitive drum 1, so as to be placed into the cleaning device 7, and the photosensitive drum 1 whose surface has been cleaned is repeatedly used for image formation. The cleaning blade 71 is a plate-shaped member made of an elastic material such as urethane rubber and is in contact with the photosensitive drum 1 in such a manner as to be oriented in a direction opposite to the direction of rotation of the photosensitive drum 1 (direction of arrow r1). Thus, in a portion where the cleaning blade 71 and the photosensitive drum 1 are in contact with each other, heat is generated by friction, and this becomes a principal factor in the increase in the temperature in an image forming area.

The fixing unit 6 includes a fixing film 61 and a pressure roller 62 built therein, and the fixing film 61 and the pressure roller 62 are respectively held in a fixing lower cover 63 and a fixing upper cover 64. The fixing film 61 is heated by a heater (not illustrated) and causes the recording material P to be introduced into a fixing nip that is formed as a result of the pressure roller 62 being pressed into contact with the fixing film 61. The fixing film 61 and the pressure roller 62 respectively rotate in a direction indicated by arrow r2 and a direction indicated by arrow r3 so as to fix the toner image onto the recording material P.

The fixing unit 6 is a unit formed of the fixing film 61, the pressure roller 62, the fixing lower cover 63, and the fixing upper cover 64 integrated with one another, and the fixing unit 6 is capable of being mounted into and unmounted from the image forming apparatus. In this example, the fixing unit 6 is introduced and mounted into the image forming apparatus in mounting and unmounting directions indicated by arrow ad2 through a right door D2 of the image forming apparatus. The mounting and unmounting directions ad2 are the horizontal direction that is substantially perpendicular to the transport surface of the conveying path region P0 extending in the top-bottom direction.

In this example, although both the image forming unit G and the fixing unit 6 are capable of being mounted into and unmounted from the image forming apparatus, a configuration in which one of the image forming unit G and the fixing unit 6 is capable of being mounted into and unmounted from the image forming apparatus may be employed. A feature of the first embodiment, that is, an air-passage configuration for cooling the image forming unit G will now be described.

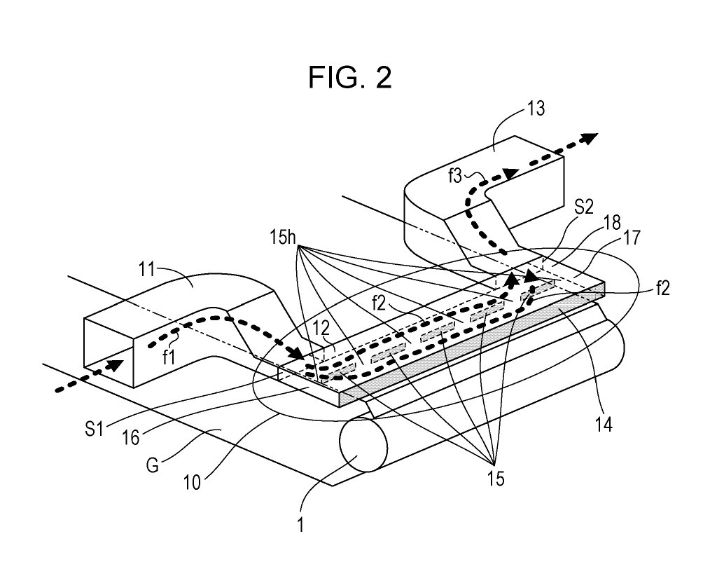

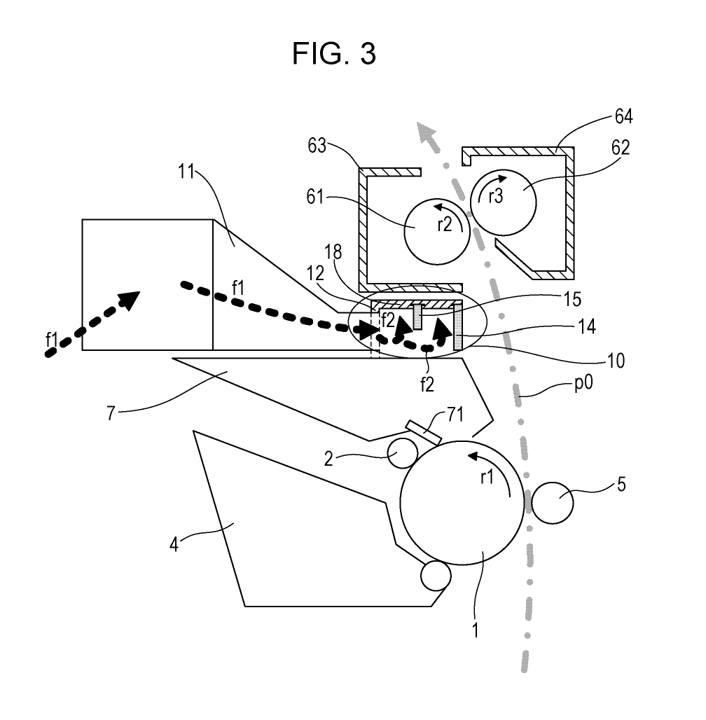

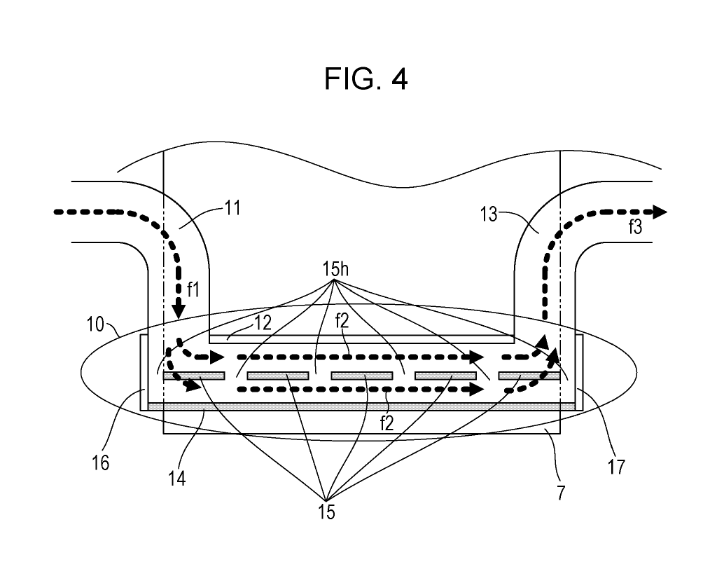

FIG. 2 is a perspective view illustrating the positional relationship between the image forming unit G and the ducts and the like, which form a cooling-air passage, and FIG. 3 is a cross-sectional side view illustrating the positional relationship between the image forming unit G, the fixing unit 6, and the ducts and the like. FIG. 4 is a top view illustrating the positional relationship between the image forming unit G and the ducts and the like. The ducts and the like are disposed above the image forming unit G and fixed to the interior of the image forming apparatus.

The intake duct 11 is connected to the air duct 10 at a connecting portion S1. The intake duct 11 guides cooling air, which is generated by an intake fan (not illustrated), in the direction of arrow f1, causes the cooling air to be introduced into the air duct 10, and discharges the cooling air from a connecting portion S2 to the outside of the image forming apparatus via the exhaust duct 13.

The air duct 10 has a rectangular parallelepiped box shape that is open on the side on which the image forming unit G is disposed and includes a main guide rib 14 and a connecting rib 12. The main guide rib 14 forms a first side surface of the air duct 10, the first side surface being located on the side on which the conveying path region P0 is disposed, and the connecting rib 12 forms a second side surface of the air duct 10, the second side surface being located on the side opposite to the side on which the conveying path region P0 is disposed. A top surface of the air duct 10 is formed of a top-surface wall 18 that is a planar wall having a rectangular shape, and first and second end-surface walls 16 and 17 are provided at the ends of the air duct 10 in the longitudinal direction of the air duct 10. There is no wall on a bottom surface side of the air duct 10, and the air duct 10 is open toward the image forming unit G.

The main guide rib 14, the connecting rib 12, the first end-surface wall 16, and the second end-surface wall 17 project downward by the same length from the four side edges of the top-surface wall 18, and for example, the lengths of the main guide rib 14, the connecting rib 12, the first end-surface wall 16, and the second end-surface wall 17 in the vertical direction is each set to 10 mm. The main guide rib 14 and the connecting rib 12 respectively extend across substantially the entire length of the first side surface of the air duct 10 and substantially the entire length of the second side surface of the air duct 10 in the longitudinal direction of the air duct 10 while being parallel to each other.

In the air duct 10, an auxiliary guide rib 15 is provided between the main guide rib 14 and the connecting rib 12, and the main guide rib 14 and the auxiliary guide rib 15 correspond to a plurality of guide ribs. In other words, the air duct 10 according to the first embodiment includes the two guide ribs, which are the main guide rib 14 and the auxiliary guide rib 15, as the plurality of guide ribs. Among the plurality of guide ribs provided in the air duct 10, the main guide rib 14 is the guide rib that is positioned close to the conveying path region P0 and corresponds to a first guide rib (first partition) according to the first embodiment, and the auxiliary guide rib 15 corresponds to a second guide rib (second partition).

First ends of the main guide rib 14 and the auxiliary guide rib 15 in the lateral direction of these ribs are fixed to the top-surface wall 18, which is a planar wall, and second ends of the main guide rib 14 and the auxiliary guide rib 15 are disposed so as to be close to a top surface of the image forming unit G with an interval therebetween. In particular, in this example, a top surface of the cleaning device 7 of the image forming unit G faces the lower-end opening of the air duct 10. Note that details of the configuration of the auxiliary guide rib 15 will be described later.

The connecting rib 12 that forms the second side surface of the air duct 10, the second side surface being located on the side opposite to the side on which the conveying path region P0 is disposed, is airtightly connected to the top-surface wall 18 and nearly seals a space between the connecting portion S1 of the intake duct 11 and the connecting portion S2 of the exhaust duct 13. The first and second end-surface walls 16 and 17 control the cooling air such that the cooling air will not flow out from the air duct 10 in a direction toward the first and second side surfaces.

A lower end of the connecting rib 12, a bottom surface of the intake duct 11, and a bottom surface of the exhaust duct 13 as well as a lower end of the main guide rib 14 and a lower end of the auxiliary guide rib 15 are arranged so as to face the cleaning device 7 of the image forming unit G in a non-contact manner, so that the mounting and unmounting of the image forming unit G into and from the image forming apparatus will not be obstructed. The distance from each of the ends of the main guide rib 14 and the connecting rib 12 to the cleaning device 7 of the image forming unit G after the image forming unit G has been mounted in the image forming apparatus is set to, for example, about 4 mm, which is a distance that allows for a space required when mounting and unmounting the image forming unit G into and from the image forming apparatus.

Regarding the mounting and unmounting directions of the image forming unit G, even in the case where a configuration is employed in which the image forming unit G is mounted into and unmounted from the image forming apparatus in a direction the same as the longitudinal direction of the image forming unit G, that is, a direction the same as the longitudinal direction of the air duct 10, the mounting and unmounting of the image forming unit G will not be obstructed by the ducts and the like. Thus, the distance from the end of the main guide rib 14 to the cleaning device 7 of the image forming unit G and the distance from the end of the connecting rib 12 to the cleaning device 7 of the image forming unit G can be set equal to each other regardless of the mounting and unmounting directions, and the cooling air can be effectively prevented from flowing to the side on which the fixing unit 6 is disposed.

Note that since the fixing unit 6 is disposed above the air duct 10 and is a unit that is mounted into and unmounted from the image forming apparatus, the fixing unit 6 is adjacent to the air duct 10 with a predetermined space between the fixing unit 6 and a bottom surface of the fixing lower cover 63. This predetermined space is set to, for example, about 4 mm.

The cooling air, which has been guided to the air duct 10, is controlled by the main guide rib 14 so as to flow in the direction of arrow f2 to the downstream side in the longitudinal direction of the air duct 10 where the pressure is lower. That is to say, the flow direction of the cooling air is changed from the direction f 1 to the direction f2 in the connecting portion S1.

The exhaust duct 13 is connected to a downstream end of the air duct 10 in the longitudinal direction of the air duct 10 at the connecting portion S2, and the cooling air is discharged to the outside of the image forming apparatus as a result of the flow direction of the cooling air being changed to the direction of arrow f 3. Although, in the image forming apparatus according to the first embodiment, the cooling air is naturally discharged from the exhaust duct 13 due to the difference between the pressure in the air duct 10 and the pressure outside the image forming apparatus, an exhaust fan may be connected to the exhaust duct 13. In the case where such an exhaust fan is provided, the cooling air can flow more actively from the air duct 10 through the exhaust duct 13.

As described above, by causing the cooling air to flow into the air duct 10, which is disposed above the cleaning device 7, the top surface of the cleaning device 7 can be directly cooled, and an increase in the temperature of the cleaning device 7 caused by the cleaning blade 71 can be reduced while blocking radiant heat from the fixing unit 6.

The auxiliary guide rib 15, which is a feature of the air duct 10 according to the first embodiment, will now be described in more detail.

The auxiliary guide rib 15 projects from the top-surface wall 18 of the air duct 10 in a downward direction and extends across the entire length of the air duct 10 in the longitudinal direction of the air duct 10. The auxiliary guide rib 15 is arranged between the main guide rib 14 and the connecting rib 12 so as to be parallel to the main guide rib 14 and the connecting rib 12. In addition, a plurality of the auxiliary rib 15 may be arranged in a plurality of rows.

The lengths of non-opening portions of the auxiliary guide rib 15 in the lateral direction (the vertical direction) are each set to be smaller than the length of a non-opening portion of the main guide rib 14 in the lateral direction (the vertical direction), the main guide rib 14 serving as the first guide rib positioned closer to the conveying path region P0 than the auxiliary guide rib 15 is. The non-opening portions of the auxiliary guide rib 15 are portions of the auxiliary guide rib 15 in which openings 15h are not formed in the longitudinal direction.

In the case where the length of the auxiliary guide rib 15 in the lateral direction is equal to that of the main guide rib 14, the cooling air is obstructed from spreading in a direction of the conveying path region P0, and a portion of the top surface of the cleaning device 7 in a relevant area cannot be cooled.

In particular, in this example, the length of the connecting rib 12, which is disposed on the side on which the intake duct 11 is connected to the air duct 10, in the lateral direction (the vertical direction) is also the same as the length of the main guide rib 14, and a probability of the cooling air flowing out is reduced as much as possible so as to improve cooling efficiency.

Regarding the lateral direction, for example, the lengths of the main guide rib 14 and the connecting rib 12 in the lateral direction are each set to 10 mm, and the length of the auxiliary guide rib 15 in the lateral direction is set to about 5 mm.

An opening ratio of the auxiliary guide rib 15 is larger than that of the main guide rib 14, which is the first guide rib. Here, the opening ratio is the ratio of the total area of openings to a cross-sectional area of the air duct paralleled with a rib wall surface of the main guide rib 14.

In this example, the auxiliary guide rib 15 is provided in the air duct 10 in such a manner that the auxiliary guide rib 15 has an opening, through which air leaks to the conveying path region P0, larger than that of the main guide rib 14.

That is to say, the rib wall surface of the main guide rib 14 according to the first embodiment does not have an opening in the longitudinal direction. The main guide rib 14 serves to isolate the conveying path region P0 and the air passage from each other. Thus, in order to prevent the cooling air from flowing toward the fixing nip, the rib wall surface of the main guide rib 14 may not have an opening. In contrast, the auxiliary guide rib 15 has the openings 15h, which are six openings including the gaps between the auxiliary guide rib 15 and the first end-surface walls 16 and 17, and portions of the rib wall each having a length in the lateral direction are arranged in a discontinuous manner in the longitudinal direction. In other words, the auxiliary guide rib 15 is disposed in such a manner that portions thereof are separated from one another by a plurality of gaps in the longitudinal direction.

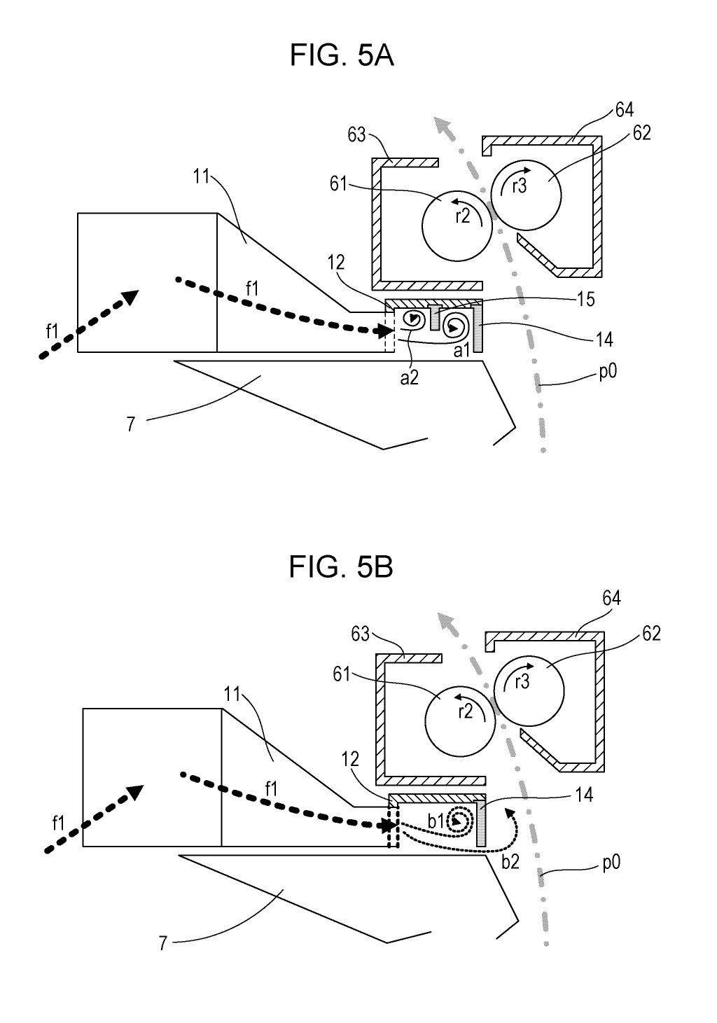

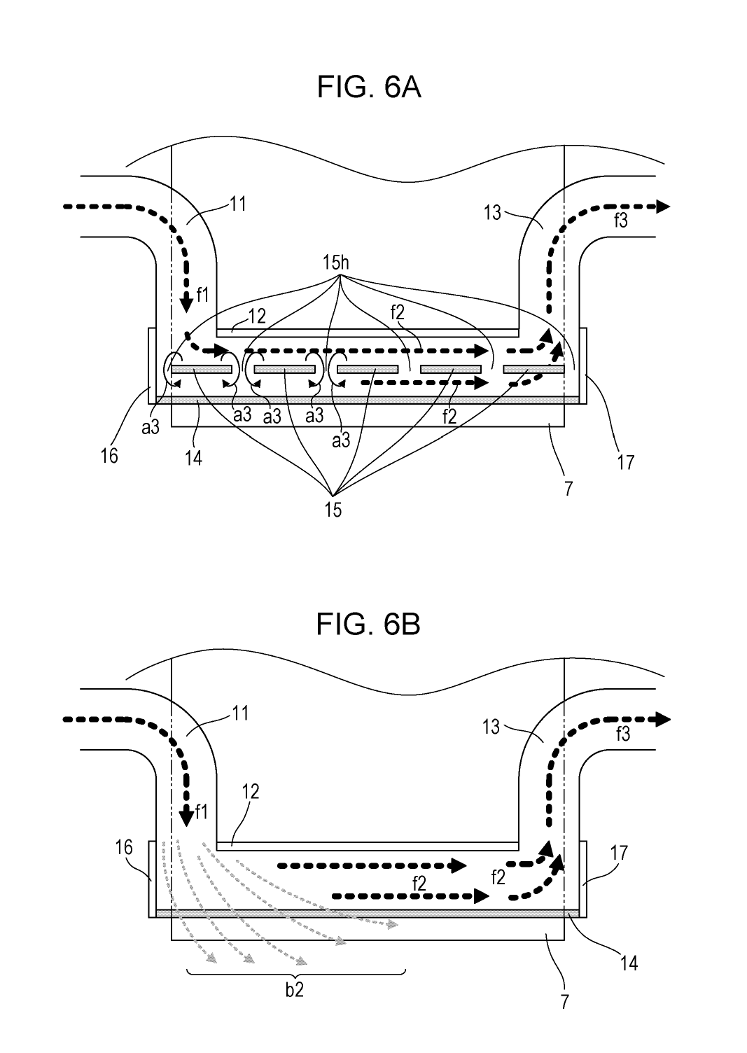

Advantageous effects of the auxiliary guide rib 15 will now be described with reference to FIGS. 5A to 6 B by comparing the case where the auxiliary guide rib 15 is provided and the case where the auxiliary guide rib 15 is not provided.

FIGS. 5A and 5B are cross-sectional side views illustrating the configuration of the peripheral portion of the air duct 10. FIG. 5A is a diagram illustrating the case where the auxiliary guide rib 15 is provided, and FIG. 5B is a diagram illustrating the case where the auxiliary guide rib 15 is not provided. FIGS. 6A and 6B are top views illustrating the configuration of the peripheral portion of the air duct 10. FIG. 6A is a diagram illustrating the case where the auxiliary guide rib 15 is provided, and FIG. 6B is a diagram illustrating the case where the auxiliary guide rib 15 is not provided.

In the case where the auxiliary guide rib 15 is not provided (see FIG. 5B and FIG. 6B), since the intake duct 11 is connected to the air duct 10 at substantially right angles, the cooling air, which is introduced to the air duct 10 from the connecting portion Si, travels toward the main guide rib 14. Thus, the cooling air generates turbulence b1 whose rotation direction is the vertical direction in the vicinity of the main guide rib 14, and the turbulence b1 functions as a resistance to the flow of the cooling air, so that an advantageous effect of causing the cooling air to flow to the downstream side of the air duct 10 is obtained. However, since there is a gap between the main guide rib 14 and the cleaning device 7, air b 2 that is included in the cooling air passes below the main guide rib 14 and flows, together with the recording material P, in a direction toward the fixing unit 6, and as a result, the cooling air cools the fixing film 61.

In contrast, in the case where the auxiliary guide rib 15 is provided (see FIG. 5A), although the cooling air travels toward the main guide rib 14 as in the case where the auxiliary guide rib 15 is not provided, since the auxiliary guide rib 15 is provided, turbulence al whose rotation direction is the vertical direction is generated in the vicinity of the main guide rib 14, and in addition, turbulence a2 whose rotation direction is the vertical direction is generated on the rib wall surface that is located on the side opposite to the side on which the main guide rib 14 is disposed.

In addition, as illustrated in FIG. 6A, turbulence a3 whose rotation direction is the horizontal direction is generated in the openings 15h of the auxiliary guide rib 15. This is because the cooling air is introduced to the air duct 10 from the connecting portion S1, and consequently, the pressure is high at the rib wall surface of the auxiliary guide rib 15 on the side on which the connecting portion S1 is present, and the pressure is low at the other rib wall surface on the side on which the conveying path region P0 is disposed. The turbulence a3 whose rotation direction is the horizontal direction is generated at each of the ends of the rib wall surfaces due to the pressure difference. By generating the two above-mentioned types of turbulence, the speed at which the cooling air flows toward the gap below the main guide rib 14 can be reduced, and the probability of the cooling air flowing to the side on which the fixing unit 6 is disposed can be reduced as much as possible without hermetically sealing the cleaning device 7.

As described above, the cooling air that is introduced from the side surface of the air duct 10, the side surface being located on the side opposite to the side on which the conveying path region P0 is disposed, by the intake duct 11 flows through the air duct 10 toward the side on which the conveying path region P0 is disposed. Then, the cooling air generates turbulence on the upstream side and the downstream side of the rib wall surface of the auxiliary guide rib 15, which is the second guide rib, and also generates, in the openings 15h of the rib wall surface of the auxiliary guide rib 15, turbulence that causes the cooling air to flow to the downstream backside of the rib wall surface. The wall-surface opening ratio of the main guide rib 14, which is positioned closer to the conveying path region P0 than the auxiliary guide rib 15 is, is set to be smaller than that of the second guide rib, and the passage of the cooling air toward the side on which the conveying path region P0 is disposed is narrow.

With the above-described configuration, the speed at which the cooling air flows toward the side on which the conveying path region P0 is disposed can be reduced. As a result, the cooling air that flows toward the fixing unit 6 can be reduced, and the components of the fixing unit 6 can be prevented from being cooled.

Note that, in a direction from the connecting rib 12 to the conveying path region P0, the main guide rib 14 and the auxiliary guide rib 15 have a relative positional relationship, and a guide rib having a large wall-surface opening ratio may be positioned farther from the conveying path region P0 than a main guide rib having a small wall-surface opening ratio is.

Alternatively, although this is not related to the advantageous effects of aspects of the present invention, while maintaining the above-described opening-ratio relationship, a guide rib for enabling air to flow that has a large opening ratio may be provided at a position closer to the conveying path region P0 than the main guide rib 14 is.

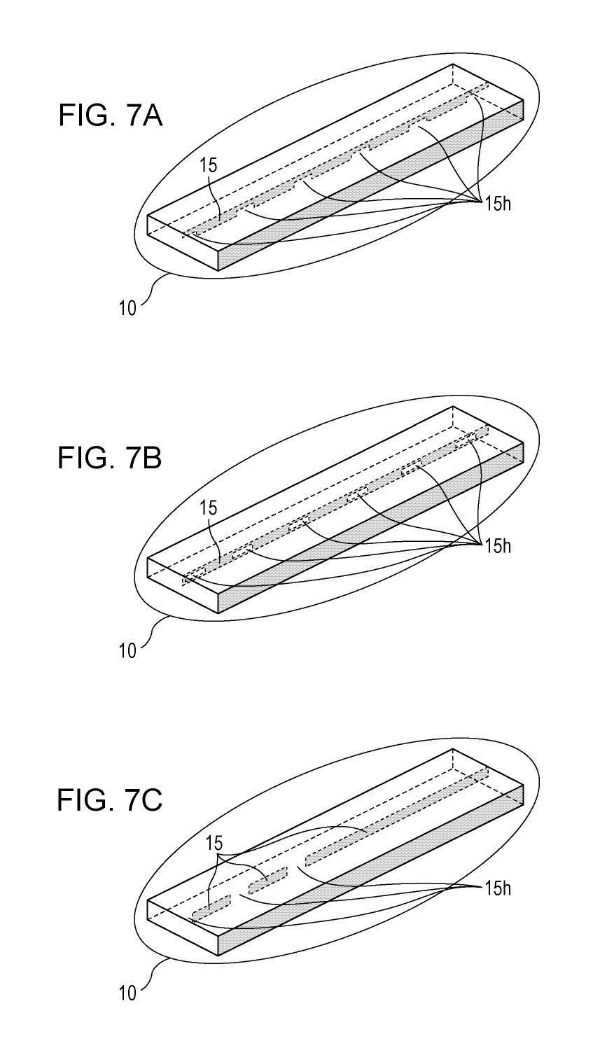

Note that, in the auxiliary guide rib 15 according to the first embodiment illustrated in FIG. 2, FIG. 3, and FIG. 4, the openings 15h are formed by cutting out portions of the rib wall surface of the auxiliary guide rib 15. In this example, the length of the rib wall in the lateral direction (vertical direction) is, for example, about 5 mm, and the length of the rib wall surface in the lateral direction (vertical direction) in each of the openings 15h is 0 mm. However, the shape of each of the openings 15h is not limited to such a notch-like shape. For example, as illustrated in FIG. 7A, the length of the rib wall surface in the lateral direction in each of the openings 15h may be partially left uncut while each of the openings 15h has a notch-like shape. In other words, the openings 15h can be formed by partially reducing the length of the rib wall surface in the lateral direction.

Instead of forming each of the openings 15h into a notch-like shape, the openings 15h may be formed of holes formed in the rib wall surface as illustrated in FIG. 7B. Note that the shapes of the openings 15h and the number of the openings 15h may be set in accordance with the flow rate of the cooling air in the image forming apparatus, the volume of the air duct 10, and the like.

Regarding the direction in which the cooling air flows through the air duct 10, the flow rate of the cooling air toward the main guide rib 14 is reduced on the downstream side of the air duct 10, and the cooling air mainly flows toward the downstream side of the air duct 10. Accordingly, the number of the openings 15h may be reduced on the downstream side as illustrated in FIG. 7C. In other words, the pitch of the openings 15h with respect to the rib wall surface of the auxiliary guide rib 15, which is the second guide rib, in the longitudinal direction of the auxiliary guide rib 15 can be varied as necessary.

### Performance Evaluation in First Embodiment

Performance evaluation of the air duct 10 according to the first embodiment will now be described.

In a state where the fixing unit 6 was cooled to an environmental temperature, the evaluation was performed under conditions of a process speed of 350 mm/s, a measured environmental temperature of 25° C., and a surface temperature of 180° C. to 200° C. of the fixing film 61. Under these conditions, an unfixed toner image T (solid black image) was formed on the entire surface of a recording material P whose basis weight is 80 g/m², and fixing performance was evaluated when ten recording materials P on each of which the toner image T had been formed were printed out in a continuous manner.

In the evaluation, a configuration in which the auxiliary guide rib 15 was provided in the air duct 10 in the image forming apparatus according to the first embodiment and a configuration of Comparative Example 1 in which the auxiliary guide rib 15 was not provided were used. Table 1 shows results of the evaluation.

TABLE 1

| Temperature of | | |
|---|---|---|
| Fixing Film | First Embodiment | Comparative Example 1 |
| 180° C. | Fixing Failure on | — |
| | Tenth Page | |
| 185° C. | Fixing Failure on | — |
| | Second Page | |
| 190° C. | No Fixing Failure | Fixing Failure on |
| | | Tenth Page |
| 195° C. | — | Fixing Failure on |
| | | Third Page |
| 200° C. | — | No Fixing Failure |

As shown in Table 1, in the image forming apparatus according to the first embodiment, a fixing failure did not occur when the surface temperature of the fixing film 61 was set to 190° C. In contrast, in Comparative Example 1 in which the auxiliary guide rib 15 was not provided, it was necessary to set the temperature of the fixing film 61 to 200° C. in order to prevent the occurrence of a fixing failure.

As described above, according to the first embodiment, by disposing the auxiliary guide rib 15, whose wall-surface opening ratio is larger than that of the main guide rib 14, in the air duct 10, the cooing air can be prevented from flowing into the fixing unit 6 without hermetically sealing the cooling-air passage. As a result, a fixation temperature can be reduced so as to be low.

### Second Embodiment

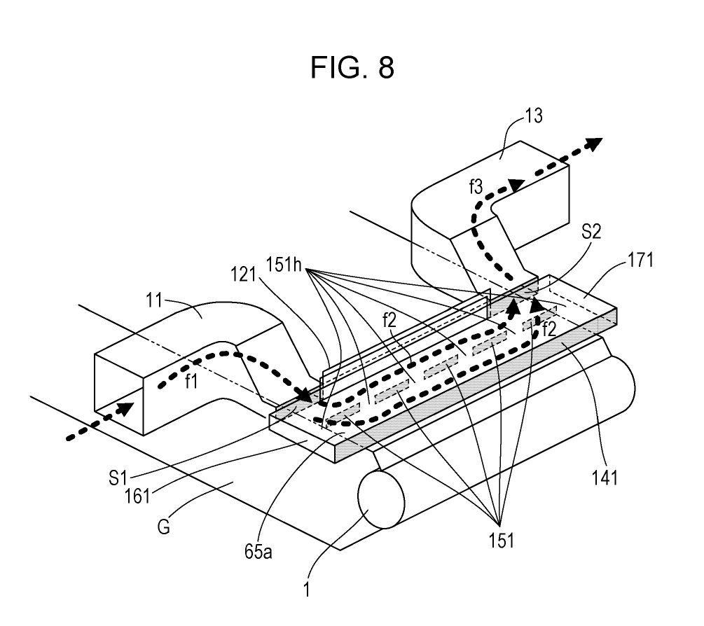

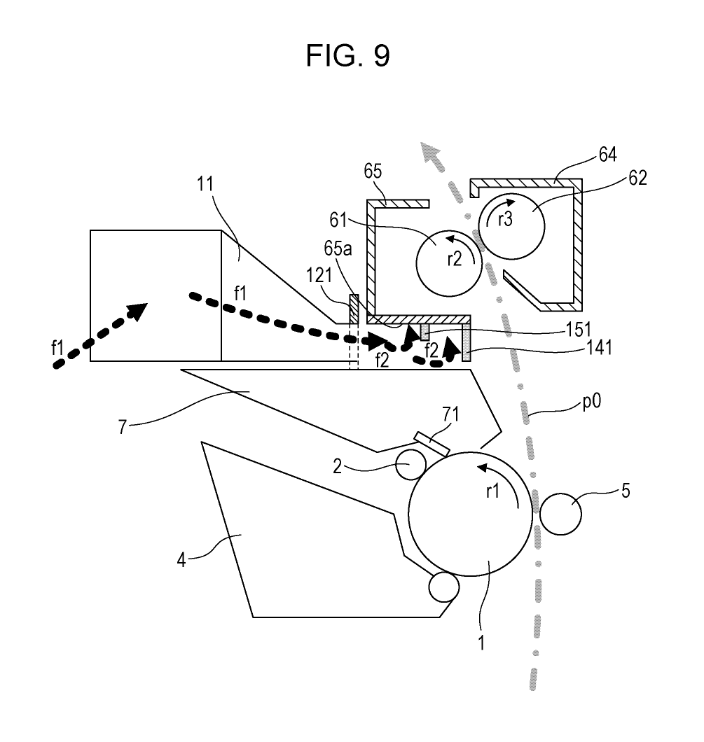

A second embodiment of the present invention will now be described with reference to FIG. 8 and FIG. 9.

In the following description, components that are the same as those described in the first embodiment are denoted by the same reference numerals, and repeated descriptions thereof will be omitted.

A feature of an image forming apparatus according to the second embodiment is that the printing performance of the image forming apparatus is improved while achieving advantageous effects equivalent to those of the image forming apparatus according to the first embodiment by using a smaller space.

FIG. 8 is a perspective view illustrating the positional relationship between the image forming unit G and ducts and the like that form a cooling-air passage according to the second embodiment. Regarding the fixing unit 6 illustrated in FIG. 8, only a bottom surface portion 65a of a fixing lower cover 65 and components that are provided on the bottom surface portion 65a are illustrated, and the other portions of the fixing unit 6 are not illustrated. FIG. 9 is a cross-sectional side view illustrating the positional relationship between the image forming unit G, the fixing unit 6, and the ducts and the like according to the second embodiment.

In contrast to the first embodiment in which the air duct 10 is formed of a component dedicated to the air duct 10, an air duct 110 according to the second embodiment is formed of the peripheral components in a space between the image forming unit G and the fixing unit 6.

In other words, the air duct 110 also has a box shape that is open on the side on which the image forming unit G is disposed and includes a main guide rib 141 and a connecting rib 121. The main guide rib 141 forms a first side surface of the air duct 110, the first side surface being located on the side on which the conveying path region P0 is disposed, and the connecting rib 121 forms a second side surface of the air duct 110, the second side surface being located on the side opposite to the side on which the conveying path region P0 is disposed. A top surface of the air duct 110 is formed of a top-surface wall that is a planar wall, and first and second end-surface walls 161 and 171 are provided at the ends of the air duct 110 in the longitudinal direction of the air duct 110. There is no wall on a bottom surface side of the air duct 110, and the air duct 110 is open toward the image forming unit G.

In the second embodiment, the planar wall (top-surface wall) that forms the top surface of the air duct 110 is formed of a cover (exterior cover) included in the fixing unit 6, which is the bottom surface portion 65a of the fixing lower cover 65 in this example. The main guide rib 141 located on the side on which the conveying path region P0 is disposed is formed of an extended portion of the cover of the fixing unit 6. In this example, the main guide rib 141 is formed of an extended portion that is formed by bending downward an extended end portion of the bottom surface portion 65a of the fixing lower cover 65.

In the air duct 110, an auxiliary guide rib 151 is provided between the main guide rib 141 and the connecting rib 121, and the main guide rib 114 and the auxiliary guide rib 151 correspond to a plurality of guide ribs.

The main guide rib 141 is the first guide rib that is positioned close to the conveying path region P0, and the auxiliary guide rib 151 is the second guide rib that is positioned far from the conveying path region P0. The opening ratio of the auxiliary guide rib 151 is larger than the opening ratio of the main guide rib 141, which is the first guide rib. Here, the opening ratio is the ratio of the total area of openings to a cross-sectional area of the air duct paralleled with a rib wall surface of the main guide rib 14.

Also in the second embodiment, the plurality of openings 15h are formed in the auxiliary guide rib 151 that corresponds to the second guide rib, which is positioned far from the conveying path region P0, and thus, the opening ratio of the auxiliary guide rib 151 is larger than the opening ratio of the main guide rib 141.

The main guide rib 141, the auxiliary guide rib 151, and the first and second end-surface walls 161 and 171 are provided on the bottom surface portion 65a of the fixing lower cover 65 of the fixing unit 6, which forms the top surface of the air duct 110. The connecting rib 121 is disposed between the connecting portion S1 of the intake duct 11 and the connecting portion S2 of the exhaust duct 13, and an upper end portion of the connecting rib 121 in the lateral direction of the connecting rib 121, which is an end portion on the side on which the fixing unit 6 is disposed, extends further toward the upper side in the vertical direction than the bottom surface portion 65a of the fixing lower cover 65. The upper end portion is disposed so as to be close to a side surface of the fixing unit 6, which is a vertical side surface 65b of the fixing lower cover 65 in this example, with a predetermined gap (e.g., a gap of about 3 mm) therebetween in the horizontal direction.

As described above, the air duct 10, which is formed of a dedicated component for the air duct 10, such as that used in the first embodiment is not used in the second embodiment, and the top surface of the air duct 110 is formed of the fixing lower cover 65. Thus, an arrangement in which the fixing unit 6 is closer to the image forming unit G is realized. Consequently, the height of the image forming apparatus according to the second embodiment can be reduced so as to be smaller than that of the image forming apparatus according to the first embodiment, and an improvement in the printing speed and a reduction in the first print-out time can be achieved by reducing the length of the conveying path region P0.

In addition, similar to the auxiliary guide rib 15 according to the first embodiment, the auxiliary guide rib 151 generates turbulence in the peripheral area thereof by operation of the openings 15h. Therefore, similar to the first embodiment, the speed at which the cooing air flows toward the conveying path region P0 in the vicinity of the connecting portion S1 can be reduced, and the probability of the cooling air flowing into the fixing unit 6 can be reduced as much as possible.

The intake duct 11 and the exhaust duct 13 are arranged so as to be close to the fixing lower cover 65 and the first and second end-surface walls 161 and 171 without being connected to the fixing lower cover 65 and the first and second end-surface walls 161 and 171. The connecting rib 121 is also disposed so as to be close to the fixing lower cover 65 without being connected to the fixing lower cover 65. Accordingly, there is a possibility that the cooling air may flow out at these positions.

However, since the cooling air is guided so as to flow in the longitudinal direction of the bottom surface portion 65a of the fixing lower cover 65 as a result of turbulence being generated by the auxiliary guide rib 151, only a small amount of the cooling air will flow out in the vicinity of the first end-surface wall 161 and the connecting rib 121.

In addition, by connecting an exhaust fan (not illustrated) to the exhaust duct 13 so as to increase a guiding force that causes the cooling air to be discharged, the cooling air can be prevented from flowing out in the vicinity of the second end-surface wall 171.

As described above, by disposing the main guide rib 141 and the auxiliary guide rib 151 on the bottom surface portion 65a of the fixing lower cover 65 of the fixing unit 6, an improvement in the printing speed and a reduction in the first print-out time can be achieved while keeping functions similar to those of the image forming apparatus according to the first embodiment, and the height of the image forming apparatus can be reduced so as to be small.

While aspects of the present invention have been described with reference to exemplary embodiments, it is to be understood that aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-193860, filed Sep. 30, 2015, which is hereby incorporated by reference herein in its entirety.

What is claimed is:

1. An image forming apparatus that forms an image on a recording material, the image forming apparatus comprising:
an image forming section that forms an unfixed toner image on a recording material;
a fixing section that heats the recording material, on which the unfixed toner image has been formed in the image forming section, and fixes the unfixed toner image onto the recording material;
an air passage that is disposed between the fixing section and the image forming section and that is adjacent to a conveying region in which the recording material is conveyed from the image forming section toward the fixing section;
an air-blowing unit configured to generate, in the air passage, airflow directed in a longitudinal direction of the fixing section;
a first partition that faces a conveying path region and partitions the air passage with respect to the conveying region; and
a second partition that partitions a region in the air passage, the second partition being disposed in such a manner as to oppose the conveying region across the first partition,
wherein a total area of an opening formed by the first partition in the air passage is smaller than a total area of an opening formed by the second partition in the air passage.

2. The image forming apparatus according to claim 1,
wherein the fixing section is configured to be mounted into and unmounted from the image forming apparatus.

3. The image forming apparatus according to claim 1,
wherein the first partition is disposed in the fixing section.

4. The image forming apparatus according to claim 3,
wherein the second partition is disposed in the fixing section.

5. The image forming apparatus according to claim 1,
wherein the image forming section includes a photoconductor and a developing section.

6. The image forming apparatus according to claim 3,
wherein the fixing section includes an exterior cover, and
wherein the first partition is a rib extending from the exterior cover toward the image forming section.

7. The image forming apparatus according to claim 4,
wherein the fixing section includes an exterior cover, and
wherein the first partition and the second partition are respectively a first rib and a plurality of second ribs, the first rib and the plurality of second ribs each extending from the exterior cover toward the image forming section.

8. The image forming apparatus according to claim 7,
wherein each of the plurality of second ribs has a length that is shorter than a length of the first rib in a direction from the fixing section toward the image forming section.

9. The image forming apparatus according to claim 8,
wherein the plurality of second ribs are disposed with intervals between the plurality of second ribs in the longitudinal direction of the fixing section.
